(19) United States
(12) Patent Application Publication
(10) Pub. No.: US 2006/0261017 A1
(43) Pub. Date: Nov. 23, 2006

(54) Telescopic stepped display stand for writing tools

(75) Inventor: Hyun-son Yoon, Seoul (KR)

Correspondence Address: INTELLECTUAL PROPERTY LAW GROUP LLP, 12 SOUTH FIRST STREET, SUITE 1205, SAN JOSE, CA, 95113, US

(73) Assignee: Morris Corporation

(21) Appl. No.: 11/271,095

(22) Filed: Nov. 10, 2005

(30) Foreign Application Priority Data
May 19, 2005 (KR) 10-2005-0042123

(51) Int. Cl. B43M 17/00

(52) U.S. Cl. 211/69.1

(57) ABSTRACT

Disclosed herein is a telescopic stepped display stand for writing tools. The display stand for writing tools includes a body having different diameter holders telescopically arranged in the body. Each of the holders has a circular bottom wall, a cylindrical sidewall, and a plurality of partition plates placed in the space defined by the bottom wall and the sidewall such that the partition plates are spaced apart at predetermined circumferential intervals and form reception cells. The open upper end of the body is closed by a cover. The cover has a circular end wall, a cylindrical sidewall vertically extending from the edge of the end wall, and a central push rod vertically extending from the center of the inner surface of the end wall to a predetermined length. In operation, the central push rod of the cover is placed below the body and pushes the lower surface of the body so that the telescopically arranged holders are sequentially raised upwards. A variety of writing tools held upright can be placed and displayed in an orderly manner in the reception cells such that the lower ends of the upright writing tools may be put into respective reception cells. This telescopic stepped display stand can be efficiently placed in a limited space, such as a space having limited height in a rack or a bookshelf.

### BACKGROUND OF THE INVENTION

1. Field of the Invention

The present invention relates, in general, to stepped display stands for writing tools and, more particularly, to a telescopic stepped display stand for writing tools, in which a plurality of writing tools held upright can be placed and displayed in an orderly manner in a plurality of reception cells provided in each of a plurality of telescopic stepped holders such that the lower ends of the upright writing tools are put into respective reception cells.

2. Description of the Related Art

Generally, conventional stands for writing tools have been configured as containers, which receive and hold a variety of writing tools therein. The container-type stands for writing tools are typically placed on users' desks, or in the show windows of stationery stores so as to receive, hold and display writing tools.

Described in detail, the conventional container-type stands for writing tools are shaped as cylindrical, square, or otherwise shaped containers, in which various writing tools, such as pencils and ballpoint pens, are received and held upright.

However, the conventional container-type stands for writing tools are problematic in that, because various writing tools are received and mixed up in a disorderly manner in one stand, it is difficult to distinguish a desired writing tool from the other writing tools which are mixed up in the stand. Thus, the conventional container-type stands for writing tools cause difficulty to users trying to find desired writing tools among the writing tools in the stand.

Furthermore, when the conventional container-type stands for writing tools receive and display a variety of writing tools for sale in a stationery store, it is very difficult for consumers to compare the different writing tools, mixed up in the writing tool stands, with each other. Thus, the conventional container-type stands for writing tools cannot display writing tools for sale in a desired manner.

In addition, when writing tools are received and mixed up in a conventional cylindrical or square stand, the writing tools collectively lean to one side. In the above state, the stand, having the writing tools which collectively lean to one side, may lose balance and tip over on a support surface, thereby causing the writing tools to fall out of the stand. Thus, the conventional container-type stands for writing tools are inconvenient to users.

In an effort to overcome the above-mentioned problems, Korean Utility Model Registration No. 20-0259048 discloses a stepped stand for writing tools, in which a variety of writing tools can be put into a plurality of reception holes of the stand in an orderly manner, thus enhancing the display effect of the writing tools for sale.

As shown in FIG. 1, the above-mentioned stepped stand for writing tools comprises a body 10 having a plurality of fixed annular steps 20 which are sequentially raised upwards in a direction from the outside to the center such that the outermost step is the lowest step and the central step is the highest step. A plurality of reception holes 30 is formed on each of the fixed annular steps 20 such that the holes 30 are spaced apart at predetermined intervals. Thus, a variety of writing tools 50 can be put into the reception holes 30 and displayed for sale.

However, the above-mentioned fixed stepped stand for writing tools does not have any outside protective wall surrounding the outside edge of the body 10, or any cover which can cover the upper end of the body 10. Thus, when the stepped stand is moved, the writing tools 50 which are put in the reception holes 30 may be easily removed from the holes 30, thus being easily lost.

Furthermore, the reception holes 30 of the stepped stand are shallow so that only the lower ends of writing tools 50 in upright states can be put into the holes 30. Thus, if a slight external shock is applied to the stepped stand, the upright writing tools 50, which have been put in the holes 30, may be easily removed from the holes 30 and fall down on the ground.

Particularly, when the body 10 is slightly tilted to one side or tips over on a support surface, the writing tools, which have been put in the holes 30, are removed from and fall out of the holes 30 at the same time. In the above state, a user is forced to put the writing tools 50 into the reception holes 30 of the body 10 one by one while wasting much time after placing the body 10 horizontally on the support surface, so that the fixed stepped stand for writing tools is inconvenient to the user.

Furthermore, the conventional stepped stand for writing tools is realized as a fixed step-shaped body 10, in which the annular steps 20 are sequentially raised upwards in a direction from the outside to the center, and the steps 20 are integrally formed as a single structure through a single molding process. Thus, the higher central portion of the fixed step-shaped body 10 cannot be retracted, so that it is impossible to place the stepped stand in a limited space, such as a space having limited height in a rack or a bookshelf.

### SUMMARY OF THE INVENTION

Accordingly, the present invention has been made keeping in mind the above problems occurring in the prior art, and an object of the present invention is to provide a telescopic stepped display stand for writing tools, which includes a body comprising a circular bottom wall and a cylindrical sidewall integrally formed around the outside edge of the circular bottom wall.

Another object of the present invention is to provide a telescopic stepped display stand for writing tools, which comprises a plurality of holders that include circular bottom walls having different diameters and are telescopically arranged so that the holders can be sequentially raised upwards by a central push rod of a cover that pushes the central holder upwards, thereby the central holder is primarily raised upwards, and, thereafter, the raised holders can be sequentially retracted when the push rod of the cover is removed from the body.

A further object of the present invention is to provide a telescopic stepped display stand for writing tools, in which the cover is fitted over the body having the fully retracted holders, thus closing the open upper end of the body.

In order to accomplish the above object, the present invention provides a telescopic stepped display stand for writing tools, comprising: a body comprising: a plurality of different diameter holders telescopically arranged in the body, each of the holders comprising: a circular bottom wall; a cylindrical sidewall; and a plurality of partition plates placed in a space defined by the circular bottom wall and the cylindrical sidewall such that the partition plates are spaced apart at predetermined circumferential intervals and form a plurality of reception cells; and a cover to close the open upper end of the body, the cover comprising: a circular end wall; a cylindrical sidewall vertically extending from an edge of the circular end wall; and a central push rod vertically extending from the center of the inner surface of the end wall to a predetermined length, wherein the central push rod of the cover is placed below the body and pushes the lower surface of the body so that the telescopically arranged holders of the body are sequentially raised upwards.

In present invention, each of the partition plates may be attached to an associated holder such that a first side edge thereof is attached along the inner surface of the cylindrical sidewall, and a lower edge thereof is attached to the circular bottom wall.

In the present invention, each of the partition plates may be provided with both a stopper and a guide along a second side edge thereof.

In the present invention, the stopper may protrude a predetermined length from the upper end of the second side edge of each of the partition plates.

In the present invention, the guide may be vertically formed along the second side edge of each of the partition plates from a position just below the stopper to the lower end of the second side edge.

In the present invention, the holders may comprise: a first holder comprising: a first opening formed through the bottom wall of the first holder so as to allow the central push rod to pass through the first opening; a second holder comprising: a second opening formed through the bottom wall of the second holder such that the edge of the second opening is vertically aligned with the second side edges of the partition plates of the second holder, with the sidewall of the second holder being offset inwards from the outside edge of the bottom wall of the second holder by a predetermined distance equal to the length of a stopper of the first holder; a third holder comprising: a third opening formed through the bottom wall of the third holder such that the edge of the third opening is vertically aligned with the second side edges of the partition plates of the third holder, with the sidewall of the third holder being offset inwards from the outside edge of the bottom wall of the third holder by a predetermined distance equal to the length of a stopper of the second holder; and a fourth holder comprising: a center groove formed on the center of the lower surface of the bottom wall of the fourth holder and pushed by the upper tip of the central push rod, with the sidewall of the fourth holder being offset inwards from the outside edge of the bottom wall of the fourth holder by a predetermined distance equal to the length of a stopper of the third holder, wherein, when the central push rod is inserted into the first opening of the first holder and continuously pushes the holders upwards, the outside edge of the bottom wall of the fourth holder is hooked by the stopper of the third holder, the outside edge of the bottom wall of the third holder is hooked by the stopper of the second holder, and the outside edge of the bottom wall of the second holder is hooked by the stopper of the first holder, so that the holders are sequentially raised upwards in order from the center holder to the outside holder such that the center holder is raised higher than the outside holder and the holders are rotatable around the central push rod.

In the present invention, the sidewall of the first holder may be circumferentially depressed around the outer surface of a lower part thereof, thus being inserted into the cover such that the sidewall of the cover is fitted over and surrounds the depressed part of the sidewall of the first holder while being in contact with the depressed part.

In the present invention, the end wall of the cover may be provided with a circular groove on the outer surface thereof, and receives an arc-shaped handle therein.

In the present invention, the handle may be provided with a pivot at each of opposite ends thereof, thus pivoting on the end wall of the cover and being rotatable 180 degrees around the opposite ends.

In the present invention, the telescopic stepped display stand for writing tools may further comprise: an elastic locking means for securely locking the cover to the first holder, the elastic locking means being provided on each of diametrically opposite positions of each of the facing ends of the sidewalls of both the first holder and the cover.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a conventional stepped display stand for writing tools;

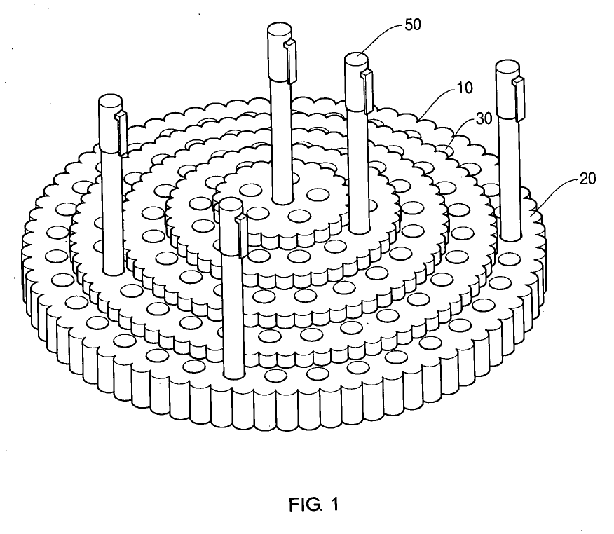

FIG. 2 is a perspective view illustrating the appearance of a telescopic stepped display stand for writing tools according to the present invention, in which a body having fully retracted holders is closed by a cover;

FIG. 3 illustrates the construction of parts of the telescopic stepped display stand according to the present invention, in an exploded perspective view and a plan view;

FIG. 4 is a perspective view illustrating the telescopic stepped display stand according to the present invention, in which a push rod of the cover is placed below the body having the fully retracted holders; and

FIG. 5 is a sectional view illustrating the telescopic stepped display stand according to the present invention, in which the holders have been fully raised by the push rod.

### DETAILED DESCRIPTION OF THE PREFERRED EMBODIMENTS

Reference now should be made to the drawings, in which the same reference numerals are used throughout the different drawings to designate the same or similar components.

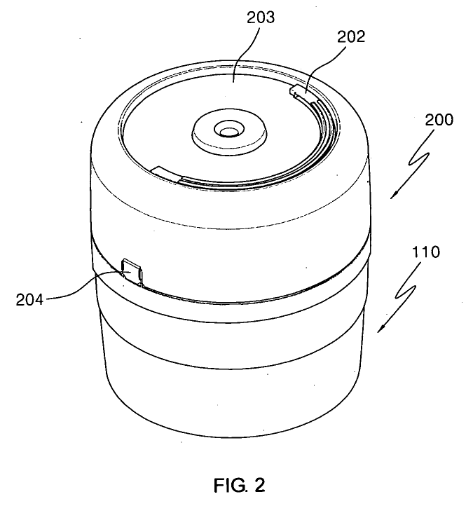

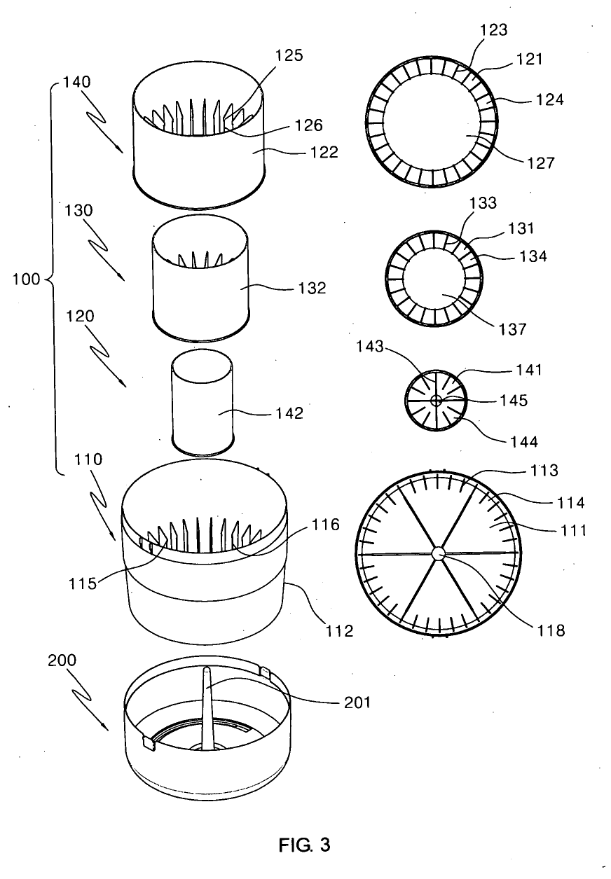

FIG. 2 is a perspective view of a telescopic stepped display stand for writing tools according to the present invention. FIG. 3 illustrates the construction of parts of the telescopic stepped display stand according to the present invention, in which the parts are shown in an exploded perspective view and a plan view.

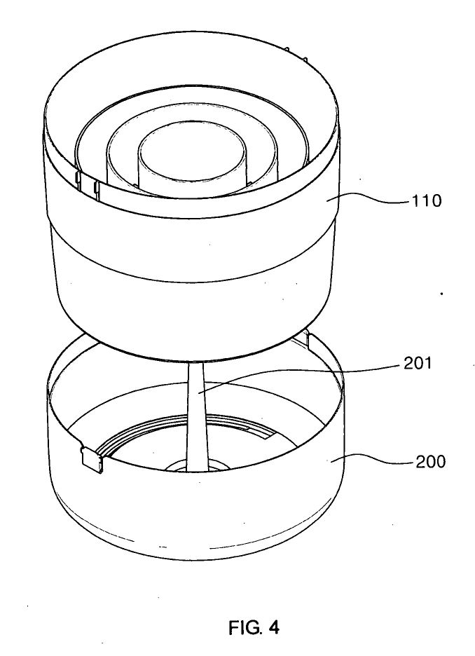

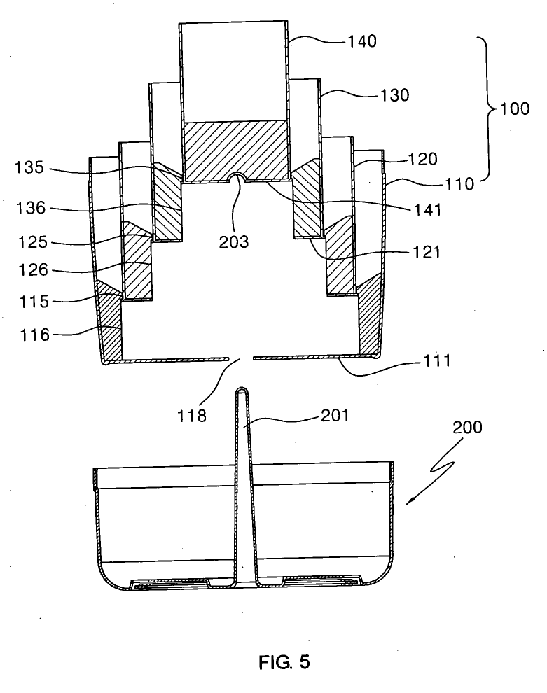

FIG. 4 is a perspective view illustrating a fully retracted state of the telescopic stepped display stand according to the present invention. FIG. 5 is a sectional view illustrating a fully raised state of the telescopic stepped display stand according to the present invention.

FIG. 2 is a perspective view illustrating the appearance of the telescopic stepped display stand for writing tools according to the present invention, when closed by a cover.

As shown in the drawings, the telescopic stepped display stand for writing tools according to the present invention comprises a body 100 and a cover 200.

The body 100 and the cover 200 are preferably made of a light synthetic resin material, such as plastic.

Each of the body 100 and the cover 200 has a bottom wall and a cylindrical sidewall which integrally extends around the edge of the bottom wall.

The body 100 comprises a plurality of holders having different diameters, which comprise circular bottom walls having different diameters and cylindrical sidewalls integrated with respective circular bottom walls. In the preferred embodiment of the present invention, the holders comprise four holders which are the first holder 110, the second holder 120, the third holder 130 and the fourth holder 140.

When the body 100 is closed by the cover 200, only the first holder 110, which forms the outermost holder, and the cover 200 are visible to a person outside the stand. In the above state, the second holder 120, the third holder 130 and the fourth holder 140 are telescopically arranged in the space defined by the cover 200 and the first holder 110 while being sequentially placed in order of diameter.

The end wall of the cover 200 is provided with a circular groove 203 on its outer surface and receives an arc-shaped handle 202 therein.

The handle 202 has two pivots at opposite ends thereof and pivots on the outer surface of the end wall of the cover 200, so that the handle 202 can be rotated 180 degrees.

Therefore, to use the handle 202, the handle 202 is rotated upwards until the handle is fully opened at a position perpendicular to the end wall of the cover 200. However, to close the handle 202, the handle 202 is rotated downwards until it is inserted into the groove 203.

A first engaging groove is formed around the inner surface of the lower end of the sidewall of the cover 200, while a second engaging groove is formed around the outer surface of the upper end of the sidewall of the first holder 110. Thus, the first and second engaging grooves can be engaged with each other.

In the above state, the cover 200 must be securely locked to the first holder 110 so that, even if the body 100, closed by the cover 200, is lifted upwards with the handle 202, the cover 200 is not undesirably removed from the body 100. Thus, each of the facing ends of the sidewalls of both the first holder 110 and the cover 200 is provided with an elastic locking means 204 at each of diametrically opposite positions of each of the facing ends.

FIG. 3 illustrates the construction of the holders of the body 100 and the cover 200, in which both the holders and the cover are illustrated in exploded perspective view on the left side of the drawing and only the holders are shown in plan view on the right side.

As shown in the drawing, the cover 200 has a central push rod 201.

The central push rod 201 is a slender rod which vertically extends from the center of the inner surface of the end wall of the cover 200 to a predetermined length and is tapered upwards to form a taper tip at the upper end.

The length of the push rod 201 is determined such that it is not longer than the sum of the lengths of three guides 116, 126 and 136 which will be described in detail later herein.

The first holder 110 has a first circular bottom wall 111 and a first cylindrical sidewall 112 which vertically extends upwards from the outside edge of the first circular bottom wall 111.

The bottom wall 111 of the first holder 110 functions to support the bottom walls of the other holders which are telescopically arranged in the space defined in the first holder 110.

A first opening 118 is formed through the center of the first bottom wall 111.

The first opening 118 has a diameter which is larger than the diameter of the central push rod 201 by about 5 mm to 7 mm, so that the central push rod 201 moves upwards and downwards through the first opening 118 unimpeded by the edge of the opening 118.

The first cylindrical sidewall 112 is slightly and circumferentially depressed around the outer surface thereof, so that the first holder 110 can be inserted into the cover 200. In the above state, the sidewall of the cover 200 is fitted over and surrounds the depressed part of the first cylindrical sidewall 112 while being in contact with the depressed part.

A plurality of first partition plates 113 is placed in the first holder 110.

The first partition plates 113 are preferably realized as thin and rigid plates which are made of the same material as the material of the first holder 110.

Each of the first partition plates 113 is securely attached to the first holder 110 such that the outside edge thereof is attached along the inner surface of the sidewall 112, and the lower edge thereof is attached to the bottom wall 111. Thus, the first partition plates 113 extend vertically and are radially oriented.

Furthermore, each of the first partition plates 113 is preferably about 20 mm to 50 mm high so that the writing tools can be stably held in reception cells defined by the partition plates 113.

The first partition plates 113 are circumferentially arranged along the inner surface of the sidewall 112 and are spaced apart from each other at predetermined intervals, so that a variety of writing tools having different diameters can be held in the reception cells defined by the partition plates 113.

A first guide 116 is formed along the inside edge of each of the first partition plates 113, with a first stopper 115 formed at the upper end of the first guide 116.

The first stopper 115 protrudes inwards by about 2 mm to 3 mm from the upper end of the first guide 116 of each first partition plate 113 in a radial direction. Due to the protruding first stopper 115, the first guide 116 is vertically formed along the inside edge of each first partition plate 113 from a position just below the first stopper 115 to the lower end of the inside edge. Thus, a cylindrical guide chamber is defined by the first guides 116.

Due to the first partition plates 113 which are arranged in the first holder 110 at predetermined intervals, a plurality of sectorial reception cells 114 is formed in the first holder 110 and may receive a variety of writing tools therein.

The second holder 120 has a second circular bottom wall 121, the radius of which is determined by subtracting the width of the lower end of one first partition plate 113 from the radius of the first bottom wall 111 of the first holder 110.

A second cylindrical sidewall 122 vertically extends upwards from a predetermined position on the second bottom wall 121, which is offset inwards from the outside edge of the second bottom wall 121 by a distance of about 2 mm to 3 mm.

The height of the second sidewall 122 is preferably set to about ¾ of the height of the first sidewall 112 of the first holder 110.

The second holder 120 has a plurality of second partition plates 123, the shape and material of which are the same as those of the first partition plates 113 of the first holder 110.

In the same manner as that described for the first partition plates 113, each of the second partition plates 123 is securely and vertically attached to the second holder 120 such that the outside edge thereof is attached along the inner surface of the sidewall 122, and the lower edge thereof is attached to the bottom wall 121.

A second opening 127 is formed through the center of the second bottom wall 121 such that the edge of the second opening 127 is vertically aligned with the inside corners of the lower ends of the second partition plates 123.

The third holder 130 has a third circular bottom wall 131, the radius of which is determined by subtracting the width of the lower end of one second partition plate 123 from the radius of the second bottom wall 121 of the second holder 120.

A third cylindrical sidewall 132 vertically extends upwards from a predetermined position on the third bottom wall 131, which is offset inwards from the outside edge of the third bottom wall 131 by a distance of about 2 mm to 3 mm. The third sidewall 132 has a height equal to that of the second sidewall 122 of the second holder 120.

The third holder 130 has a plurality of third partition plates 133, the shape and material of which are the same as those of the first partition plates 113 of the first holder 110.

In the same manner as that described for the first partition plates 113, each of the third partition plates 133 is securely and vertically attached to the third holder 130 such that the outside edge thereof is attached along the inner surface of the sidewall 132, and the lower edge thereof is attached to the bottom wall 131.

A third opening 137 is formed through the center of the third bottom wall 131 such that the edge of the third opening 137 is vertically aligned with the inside corners of the lower ends of the third partition plates 133.

The fourth holder 140 has a fourth circular bottom wall 141, the radius of which is determined by subtracting the width of the lower end of one third partition plate 133 from the radius of the third bottom wall 131 of the third holder 130.

A fourth cylindrical sidewall 142 vertically extends upwards from a predetermined position on the fourth bottom wall 141, which is offset inwards from the outside edge of the fourth bottom wall 141 by a distance of about 2 mm to 3 mm.

The fourth sidewall 142 has a height equal to that of the sidewalls 122 and 132 of the second and third holders 120 and 130.

The fourth holder 140 has a plurality of fourth partition plates 143, the shape and material of which are the same as those of the first partition plates 113 of the first holder 110.

In the same manner as that described for the first partition plates 113, each of the fourth partition plates 143 is securely and vertically attached to the fourth holder 140 such that the outside edge thereof is attached along the inner surface of the sidewall 142, and the lower edge thereof is attached to the bottom wall 141.

A center groove 145 is formed on the center of the lower surface of the fourth bottom wall 141 so that, when the telescopically arranged holders 120, 130 and 140 are sequentially pushed upwards using the push rod 201 of the cover 200, the upper tip of the push rod 201 is inserted into and pushes the center groove 145 upwards.

FIG. 4 illustrates the telescopic stepped display stand, in which the push rod 201 of the cover 200 is placed below the fully retracted body 100. FIG. 5 illustrates the telescopic stepped display stand, in which the holders of the body 100 have been fully raised by the push rod 201.

To sequentially raise the telescopically arranged holders 120, 130 and 140 of the body 100 upwards, the cover 200 is removed from the body 100 and, thereafter, is turned upside down so that the upper tip of the push rod 201 is directed upwards. Thereafter, the cover 200 is placed below the fully retracted body 100 such that the tip of the push rod 201 is inserted into the center groove 145 (see FIGS. 3 and 5) of the fourth holder 140. Thus, the push rod 201 pushes the retracted holders upwards.

In the above state, the fourth holder 140 is primarily raised upwards by the push rod 201 which has been inserted into the center groove 145 of the fourth holder 140. Thus, the outside edge of the bottom wall 141 of the fourth holder 140 is moved vertically upwards along the third guides 136 of the third holder 130.

The upward movement of the outside edge of the bottom wall 141 of the fourth holder 140 is stopped by the third stoppers 135 of the third holder 130. However, in the above state, the upward pushing force of the push rod 201 is continuously applied to the body 100, so that the third holder 130 is secondarily moved upwards along with the fourth holder 140.

The third stoppers 135 of the third holder 130 are hooked by the outside edge of the bottom wall 141 of the upward moving fourth holder 140, so that the third holder 130 is moved upwards along with the fourth holder 140. In the above state, the outside edge of the third bottom wall 131 is vertically moved upwards along the second guides 126 of the second holder 120.

The upward movement of the outside edge of the bottom wall 131 of the third holder 130 along with the fourth holder 140 is stopped by the second stoppers 125 of the second holder 120. In other words, the second stoppers 125 of the second holder 120 are hooked by the outside edge of the bottom wall 131 of the upward moving third holder 130, so that the second holder 120 is moved upwards along with both the third and fourth holders 130 and 140. In the above state, the outside edge of the second bottom wall 121 is vertically moved upwards along the first guides 116 of the first holder 110.

The upward movement of the outside edge of the bottom wall 121 of the second holder 120 along the first guide 116 is stopped by the first stoppers 115 of the first holder 110. Thus, the upward movement of the second, third and fourth holders 120, 130 and 140 is stopped.

When the holders of the body 100 have been fully raised upwards by the push rod 201 of the cover 200 and the upward movement of the holders is stopped, the lower surface of the bottom wall 111 of the first holder 110 comes into contact with the inner surface of the end wall of the cover 200. The push rod 201 in the above state supports the raised holders 120, 130 and 140, which are rotatable 360 degrees around the push rod 201.

Furthermore, when the cover 200 having the push rod 201 is removed from the lower surface of the body 100 having the raised holders 120, 130 and 140, the holders are released from the support force of the push rod 201. Thus, the outside edges of the bottom walls 121, 131 and 141 of the holders are released from the stoppers 115, 125 and 135.

Therefore, the outside edges of the bottom walls 121, 131 and 141 of the holders, which have been released from the stoppers 115, 125 and 135, drop downwards to the bottom wall 111 of the first holder 110 at the same time. Thus, the telescopic holders of the body 100 are fully retracted as shown in FIG. 4.

As described above, the present invention provides a telescopic stepped display stand for writing tools, which includes a body comprising a plurality of holders each comprising a circular bottom wall and a cylindrical sidewall integrally formed around the outside edge of the circular bottom wall, with a plurality of reception cells provided in each of the holders and receiving therein a variety of writing tools. Thus, the display stand is advantageous in that the writing tools, which are received in the reception cells of the holders, are not mixed up, aggregate, or undesirably removed from the cells.

In the telescopic stepped display stand for writing tools of the present invention, the holders of the body, which include circular bottom walls having different diameters, are telescopically arranged so that the holders can be sequentially raised upwards by a central push rod of a cover in order from the central holder to the outside holder and, thereafter, the raised holders can be sequentially retracted by removing the push rod of the cover from the raised holders of the body. Thus, the telescopic stepped display stand of the present invention can be efficiently placed in a limited space, such as a space having limited height in a rack or a bookshelf, so that the stand is not limited to large spaces. Furthermore, because the raised holders of the body of the display stand are rotatable 360 degrees around the central push rod of the cover, a consumer can easily observe the styles and qualities of the writing tools received in respective reception cells and easily compare the writing tools with each other so as to select a desired one while rotating the holders without moving around the display stand. Thus, the present display stand enhances the display effect of the writing tools for sale.

Furthermore, the body of the telescopic stepped display stand for writing tools can be securely closed by the cover such that the cover faces the retracted holders of the body. Thus, the writing tools, which are received in the reception cells, are not undesirably removed or lost from the display stand while a user moves the stand. Thus, the telescopic stepped display stand allows a user to conveniently move the display stand.

Although the preferred embodiment of the telescopic stepped display stand for writing tools according to the present invention has been disclosed with reference to the drawings for illustrative purposes, those skilled in the art will appreciate that various modifications, additions and substitutions are possible, without departing from the scope and spirit of the invention as disclosed in the accompanying claims.

What is claimed is:

1. A telescopic stepped display stand for writing tools, comprising:
a body comprising: a plurality of different diameter holders telescopically arranged in the body, each of the holders comprising: a circular bottom wall; a cylindrical sidewall; and a plurality of partition plates placed in a space defined by the circular bottom wall and the cylindrical sidewall such that the partition plates are spaced apart at predetermined circumferential intervals and form a plurality of reception cells; and
a cover to close an open upper end of the body, the cover comprising: a circular end wall; a cylindrical sidewall vertically extending from an edge of the circular end wall; and a central push rod vertically extending from a center of an inner surface of the end wall to a predetermined length, wherein
the central push rod of the cover is placed below the body and pushes a lower surface of the body so that the telescopically arranged holders of the body are sequentially raised upwards.

2. The telescopic stepped display stand for writing tools according to claim 1, wherein each of the partition plates is attached to an associated holder such that a first side edge thereof is attached along an inner surface of the cylindrical sidewall, and a lower edge thereof is attached to the circular bottom wall.

3. The telescopic stepped display stand for writing tools according to claim 1, wherein each of the partition plates is provided with both a stopper and a guide along a second side edge thereof.

4. The telescopic stepped display stand for writing tools according to claim 3, wherein the stopper protrudes a predetermined length from an upper end of the second side edge of each of the partition plates.

5. The telescopic stepped display stand for writing tools according to claim 3, wherein the guide is vertically formed along the second side edge of each of the partition plates from a position just below the stopper to a lower end of the second side edge.

6. The telescopic stepped display stand for writing tools according to claim 1, wherein the holders comprise:
a first holder comprising: a first opening formed through the bottom wall of the first holder so as to allow the central push rod to pass through the first opening;
a second holder comprising: a second opening formed through the bottom wall of the second holder such that an edge of the second opening is vertically aligned with the second side edges of the partition plates of the second holder, with the sidewall of the second holder being offset inwards from an outside edge of the bottom wall of the second holder by a predetermined distance equal to a length of a stopper of the first holder;
a third holder comprising: a third opening formed through the bottom wall of the third holder such that an edge of the third opening is vertically aligned with the second side edges of the partition plates of the third holder, with the sidewall of the third holder being offset inwards from an outside edge of the bottom wall of the third holder by a predetermined distance equal to a length of a stopper of the second holder; and
a fourth holder comprising: a center groove formed on a center of a lower surface of the bottom wall of the fourth holder and pushed by an upper tip of the central push rod, with the sidewall of the fourth holder being offset inwards from an outside edge of the bottom wall of the fourth holder by a predetermined distance equal to a length of a stopper of the third holder,
wherein, when the central push rod is inserted into the first opening of the first holder and continuously pushes the holders upwards, the outside edge of the bottom wall of the fourth holder is hooked by the stopper of the third holder, the outside edge of the bottom wall of the third holder is hooked by the stopper of the second holder, and the outside edge of the bottom wall of the second holder is hooked by the stopper of the first holder, so that the holders are sequentially raised upwards in order from the center holder to the outside holder such that the center holder is raised higher than the outside holder and the holders are rotatable around the central push rod.

7. The telescopic stepped display stand for writing tools according to claim 6, wherein the sidewall of the first holder is circumferentially depressed around an outer surface of a lower part thereof, thus being inserted into the cover such that the sidewall of the cover is fitted over and surrounds the depressed part of the sidewall of the first holder while being in contact with the depressed part.

8. The telescopic stepped display stand for writing tools according to claim 1, wherein the end wall of the cover is provided with a circular groove on an outer surface thereof, and receives an arc-shaped handle therein.

9. The telescopic stepped display stand for writing tools according to claim 8, wherein the handle is provided with a pivot at each of opposite ends thereof, thus pivoting on the end wall of the cover and being rotatable 180 degrees around the opposite ends.

10. The telescopic stepped display stand for writing tools according to claim 6, further comprising:
elastic locking means for securely locking the cover to the first holder, the elastic locking means being provided on each of diametrically opposite positions of each of the facing ends of the sidewalls of both the first holder and the cover.

11. The telescopic stepped display stand for writing tools according to claim 8, further comprising:
elastic looking means for securely locking the cover to the first holder, the elastic locking means being provided on each of diametrically opposite positions of each of the facing ends of the sidewalls of both the first holder and the cover.
